(19) United States
(12) Patent Application Publication
(10) Pub. No.: US 2023/0236860 A1
(43) Pub. Date: Jul. 27, 2023

(54) AUTOMATIC MANAGEMENT OF APPLICATION SPECIFIC AGENTS IN A VIRTUAL MACHINE USING AN APPLICATION MANAGEMENT AGENT

(71) Applicant: DELL PRODUCTS L.P., ROUND ROCK, TX (US)

(72) Inventors: Yasemin Ugur-Ozekinci, Oakville (CA); Mark Malamut, Aliso Viejo, CA (US); Jennifer Minarik, Zionsville, IN (US); Brian E. Freeman, Golden, CO (US)

(21) Appl. No.: 17/582,322

(22) Filed: Jan. 24, 2022

(51) Int. Cl. G06F 9/455; G06F 9/50

(52) U.S. Cl. CPC G06F 9/45558; G06F 9/45554; G06F 9/5072; G06F 2009/4557; G06F 2009/45595

(57) ABSTRACT

A lightweight, workload-agnostic application management agent (AMA) automatically upgrading application agents on a virtual machine (VM). The AMA is installed in the VM as part of a Gold image installation. The AMA detects a workload-type of the VM and sends the workload information to an application manager. The AMA continuously monitors the VM for any change in workload type, and any change causes the AMA to install a respective workload-specific agent (WSA) for the new workload in the VM. The AMA accesses the new WSA from the application manager though a push or pull operation. Applications are thus automatically upgraded through VM resident agents. The user needs only to update policies and load updated software to the application manager without manually upgrading the WSA agents themselves.

### TECHNICAL FIELD

This invention relates generally to large-scale data backup and storage systems, and specifically to automatic management of backup agents.

### BACKGROUND

Large-scale networks process and store large amounts of user data created by different applications and often deployed on different machines and operating systems (OS). Routine backing up of data is a critical task for any enterprise or organization, and well established products, such as DellEMC's Data Domain system are often used for providing deduplicated backup and restoration functions. Modern large-scale data storage systems often involve the deployment and use of large numbers of virtual machines (VMs) as backup targets.

With automation tools, users can easily deploy, stand-up and tear down hundreds to thousands of VMs very quickly. These VMs often contain data from various workloads such as filesystems and databases that need to be protected. Efficient data protection typically relies on workload-specific agents to be installed, running and periodically upgraded on each VM. Present systems utilize certain known products to push install an agent to a VM, or push upgrade the agent on the VM. These methods require that the user understand the type of application on that VM, push-install the workload-specific agent, upgrade the agent, and be aware of any application changes on the VM to use the right agent. These are all human-driven manual activities.

A significant amount of effort and resources are thus required by various administrators (e.g., backup administrators, application administrators, etc.) to ensure that each workload (application) specific agent on each VM is installed, operational and upgraded. In fact, this effort can be so great that it is nearly impossible to ensure the correct state of the backup agent on each VM at all times.

What is needed, therefore, is a data storage system that can co-ordinate the installation and upgrade lifecycles of all data mover agents by communicating with the data protection software.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. EMC, Data Domain and Data Domain Restorer are trademarks of DellEMC Corporation.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1 is a diagram of a network implementing an automatic backup agent management system for VM-based data storage systems, under some embodiments.

FIG. 2 illustrates the implementation of the application management agent in a virtual machine, under some embodiments.

FIG. 3 is a flowchart that illustrates the main tasks of the application management agent, under some embodiments.

FIG. 4 illustrates the interaction between an application server and each application management agent through an AMA controller, under some embodiments.

FIG. 5 is an end-to-end AMA sequence diagram showing the interaction among the various components of FIG. 4 during an automatic update of a VM application, under an example embodiment.

FIG. 6 illustrates a table showing a composition of a Gold image library storing OS, application data, and VM agent data, under some embodiments.

FIG. 7 is a flowchart illustrating an overall process of deploying and using an application management agent to upgrade application agents on a VM, under some embodiments.

FIG. 8 is a system block diagram of a computer system used to execute one or more of the processing functions described herein, under some embodiments.

### DETAILED DESCRIPTION

A detailed description of one or more embodiments is provided below along with accompanying figures that illustrate the principles of the described embodiments. While aspects are described in conjunction with such embodiment(s), it should be understood that it is not limited to any one embodiment. On the contrary, the scope is limited only by the claims and the described embodiments encompass numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random-access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information. Alternatively, or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory.

Applications, software programs or computer-readable instructions may be referred to as components or modules. Applications may be hardwired or hard coded in hardware or take the form of software executing on a general-purpose computer or be hardwired or hard coded in hardware such that when the software is loaded into and/or executed by the computer, the computer becomes an apparatus for practicing the certain methods and processes described herein. Applications may also be downloaded, in whole or in part, through the use of a software development kit or toolkit that enables the creation and implementation of the described embodiments. In this specification, these implementations, or any other form that embodiments may take, may be referred to as techniques. In general, the order of the steps of disclosed processes may be altered within the scope of the embodiments.

Some embodiments involve data processing in a distributed system, such as a cloud based network system or very large-scale wide area network (WAN), metropolitan area network (MAN), however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network.

Embodiments are described for a lightweight agent that is installed on all VMs in a large-scale data protection system. This agent will co-ordinate the installation and upgrade lifecycles of all data mover agents by communicating with the Data Protection Software. Certain backup platforms, such as Dell Data Protection Software (DPS), have agents that use a common service called ‘Agent Service’ in each workload-specific agent to perform common functionalities like full or incremental deep discovery of user data (assets), upgrade the agent and so on. Embodiments provide advantages over systems that requires considerable amount of disk space size and memory, and human direction and input to install the right agent and upgrade from a centralized location. Embodiments are directed to a lightweight agent that is installed on all VMs, and that will co-ordinate the installation and upgrade lifecycles of all data mover agents by communicating directly with the data protection software.

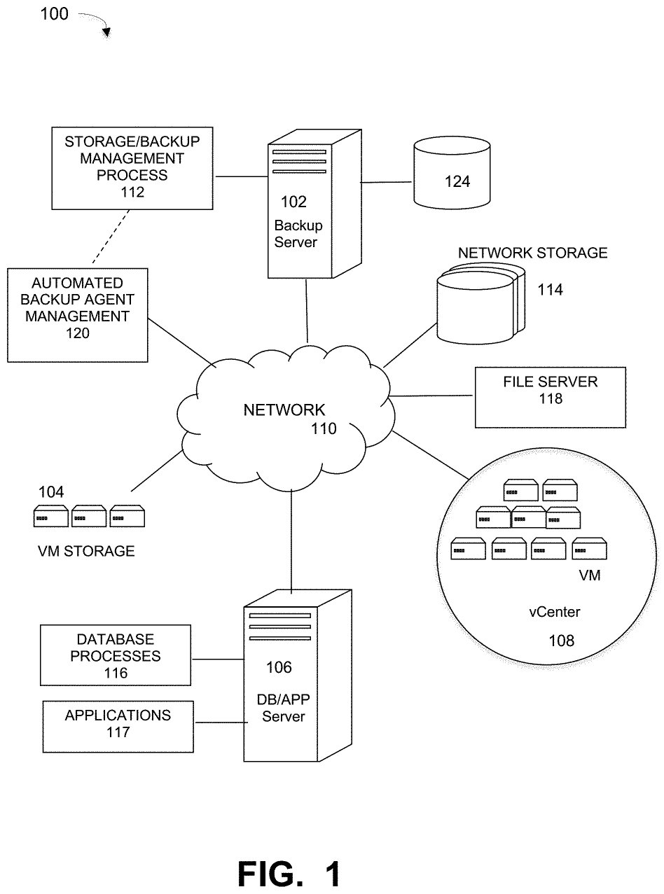

FIG. 1 is a diagram of a network implementing an automatic backup agent management system for VM-based data storage systems, under some embodiments. In system 100, a storage server 102 executes a data storage or backup management process 112 that coordinates or manages the backup of data from one or more data sources 108 to storage devices, such as network storage 114, client storage, and/or virtual storage devices 104. With regard to virtual storage 104, any number of virtual machines (VMs) or groups of VMs may be provided to serve as backup targets. FIG. 1 illustrates a virtualized data center (vCenter) 108 that includes any number of VMs for target storage. The VMs or other network storage devices serve as target storage devices for data backed up from one or more data sources, such as a database or application server 106, or the data center 108 itself, or any other data source, in the network environment. The data sourced by the data source may be any appropriate data, such as database 116 data that is part of a database management system, a file server 118 or any appropriate application 117. Such data sources may also be referred to as data assets and represent sources of data that are backed up using process 112 and backup server 102.

The network server computers are coupled directly or indirectly to the network storage 114, target VMs 104, data center 108, and the data sources 106 and other resources through network 110, which may be a public cloud network (but may also be a private cloud, LAN, WAN or other similar network). Network 110 provides connectivity to the various systems, components, and resources of system 100, and may be implemented using protocols such as Transmission Control Protocol (TCP) and/or Internet Protocol (IP), well known in the relevant arts. In a cloud computing environment, network 110 represents a network in which applications, servers and data are maintained and provided through a centralized computing platform.

The data generated or sourced by system 100 and transmitted over network 110 may be stored in any number of persistent storage locations and devices. In a backup case, the backup process 112 causes or facilitates the backup of this data to other storage devices of the network, such as network storage 114, which may at least be partially implemented through storage device arrays, such as RAID components. In an embodiment network 100 may be implemented to provide support for various storage architectures such as storage area network (SAN), Network-attached Storage (NAS), or Direct-attached Storage (DAS) that make use of large-scale network accessible storage devices 114, such as large capacity disk (optical or magnetic) arrays. In an embodiment, system 100 may represent a Data Domain Restorer (DDR)-based deduplication storage system, and storage server 102 may be implemented as a DDR Deduplication Storage server provided by EMC Corporation. However, other similar backup and storage systems are also possible.

The database 116 and other applications 117 may be executed by any appropriate server, such as server 106. Such servers typically run their own OS, such as MS Windows, Linux, and so on. The operating systems and applications comprise program code that defines the system and applications. As such, this code comprises data that is backed up and processed by backup server 102 during routine data protection backup and restore processes that involve all of the data of system 100.

As shown in FIG. 1, many backup targets and resources of system 100 are implemented using VMs, either as part of data centers 108 or networked storage targets 104. These VMs typically perform backup operations through one or more agents installed on the VM by a system administrator, or backup administrator in the case of backup system usage. Specific application platforms, especially backup programs, utilize products to install and upgrade agents on the VMs, through push processes (push install and push upgrade). An agent may be configured to cause the VM to perform one or more specific task for an application, such as discovery of a user database and filesystems. Agents are thus very workload-specific (application-specific) to the network in which they are deployed. Because of this, and as stated above, deploying, configuring, upgrading, and generally managing agents on VMs requires system resources and human interaction. Correct agents must be installed and maintained in a timely manner to ensure that network operations function smoothly and data is not compromised.

To overcome present deficiencies related to resource use and manual administrator control, embodiments are directed to a lightweight application management agent that is installed on each VM and that is workload agnostic. This application management agent (AMA) is configured to automatically detect all application types running on a VM and retrieve/install/update the appropriate workload-specific agent from the appropriate centralized repository based on the type and policies. It will also serve to ensure that the proper workload-specific agents (WSA) are correctly installed, configured, operational and upgraded on a VM.

In a data protection system, the application management agent is deployed on every VM that needs or may need to be protected. In an embodiment, the AMA can be deployed as part of a standard (Gold Image) deployment for any VM that needs to be presently backed up, or may need to be backed up in the future.

When available, users often deploy a set of standard server configurations known as ‘Gold images’ multiple times. These Gold images may be pure OS images or they may be application/OS combinations such as a SQL Server on MS-Windows, Oracle on Linux, and so on. Gold image data is static (structural/definition) data that is deployed many times by users who wish to reuse the same code across many different deployed computers or machines. As these Gold images are placed into service (deployed) in user production systems, they help generate user content data, which is subject to data protection processes that store the Gold image data along with the user data.

For organizations that use Gold Images (e.g., VMware templates) to deploy VMs, the application management agent is preferably deployed as part of the Gold Image. That is, it is included within the definition of the structural, non-content data of the VM.

For systems that do not utilize Gold Image deployment, the application management agent can be deployed onto an existing VM. For non-virtualized environments, the AMA can be part of an OS imaging and deployment procedure that system administrators may use.

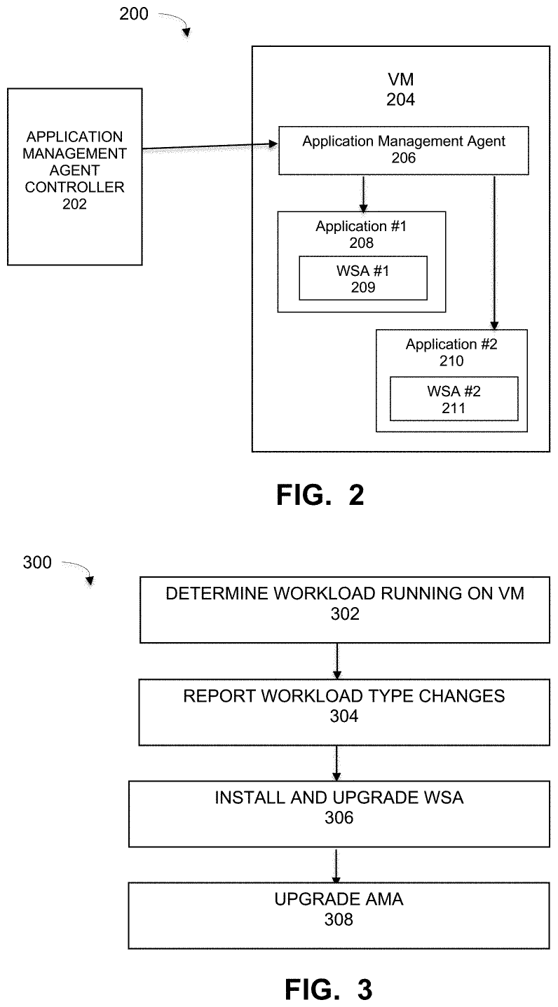

The application management agent is embodied a lightweight service to provide certain common functionality related to all workloads. FIG. 2 illustrates the implementation of the application management agent in a virtual machine, under some embodiments. As shown in FIG. 2, a virtual machine VM 204 includes one or more applications 208 and 210, each of which may use their own respective agents 209 and 211. These are each application or workload-specific agents WSAs that control the VM to execute backup tasks for their respective VM. The WSAs only exist for performing a backup. A VM may execute any practical number of applications, but VMs but will have only one WSA (e.g., 209) for performing backup functions per a backup application (e.g., 208).

As shown in FIG. 2, system 200 includes an application management agent 206 within VM 204. This agent is managed by an external AMA controller 202 that is an automatically scalable cluster managed by the backup software 112. The backup software will set policies for the AMA to execute such as the cadence of checking the WSAs, rules for upgrading WSA's and reporting on the health of the WSAs to the backup software. This enables the AMA to manage all the WSAs while minimizing the direct involvement by the backup software.

Within each VM, the application management agent performs certain configuration and lifespan management tasks for the application(s) or WSA(s) with the VM. FIG. 3 is a flowchart 300 that illustrates the main tasks of the application management agent, under some embodiments. A first task of the AMA is to determine the workload types running on the VM, 302. This comprises the applications and agents (WSAs) running on the VM. If one application is running, this is referred to as the workload type. If two or more applications of the same type are running, collectively these are known as the workload. If two or more different applications of respective types are running, these are different workload types. Thus, for example, a VM may be running one or more applications such as a filesystem, MS SQL database, Oracle database, and so on. Each of these would be a different workload in different VMs or the same VM.

For this determining step 302, each AMA will periodically discover and detect the workload types that are running locally on their VM. The detection process can be performed in a number of different ways. For example, the AMA can perform a default detection of workload types (such as SQL Server, Oracle, PostgreSQL, etc.) using application-specific mechanisms. For example, for an Oracle database, functions such as oratab or oracle core daemons or services can be used to process the lookup, for SQL a lookup of Windows services may yield the discovery of a service with a “SQL Server” substring in it, and so on.

The AMA performs a basic detection of applications running on a VM and possibly their asset(s) (e.g., databases) of each workload type, such as an Oracle database or SID on that system, SQL server instance name, and so on. The user can override or extend the default workload detection rules with custom detection rules through a configuration file that can be in the gold image or in a specific instance. Sample rules could include: hostname patterns (e.g., all the hosts that have a hostname matching “sql*” regexp are considered to be the SQL workload type), specific registry patterns, specific binary or binaries, or checking for a running daemon or service with a matching regexp.

During operation of a VM, the workload may change, such as through evolution of application usage, exception processing, redeployment, and so on. As shown in process 300, once workload determination is completed, the AMA continuously monitors the VM and reports any workload type changes, 304. In this step, the AMA discovers the workload type on the VM during regular intervals, and when it detects a new workload type and/or change in the type, it will send a Workload Detection Message to the AMA controller 202.

The AMA controller 202 is be responsible for communication with each AMA 206, and any one of a number of various ways can be used for the AMA to locate and communicate with the AMA controller. For example, the AMA can broadcast a message and AMA controller can listen to those messages. Alternatively, the AMA can use a well-known DNS name and port number to contact the AMA controller. This DNS name can be wired in the Gold Image as well as a configuration file. Other network resource or service location lookups such as DNS service location records can also be used. The AMA controller 202 will read messages that have been sent by the various AMAs and take the appropriate action.

Data protection systems like PowerProtect Data Manager allow users to set agent deployment policies that the AMA controller can use to automatically instruct the AMAs for certain classes of changes. For example a policy may specify that VMs within a certain subnet with AMAs reporting “SQL-Server” as the workload type are always approved and to have the most recently approved version of the MS-SQL backup agent deployed and running. In this case, the AMA will automatically ensure that a matching VM does so by directing (or sending) the currently approved version of the MS-SQL backup agent to AMA running on VMs that match this criteria.

Another example would be an agent deployment policy that states that VMs which have “sql” in their name to have a MS-SQL agent deployment regardless of the workload type detected. In the case of multiple agent deployment policies, users can assign policy precedence order, if the same VM matches with multiple policies.

As shown in FIG. 3, the application management agent 206 is also responsible for installation and upgrades of the WSAs on a VM, 306. For this step, the backup system (e.g., DPS) management console can periodically query the AMA controller 202 and display the details (on one or any arbitrary grouping of VMs) that includes the workload type (e.g. SQL Server), application server instances (e.g., SQL MSSQLPROD), and database names residing on each VM. This information is sent by the AMA in the workload detection notification message. This display can also show the discovered application types and what level of protection they currently have (e.g., none, crash consistent, application consistent, and so on). This view will also be actionable in that the user may choose to change the protection level of any workload in any grouping of VMs. This action will be sent to the AMA controller 202, which will co-ordinate with each AMA 204 as appropriate to perform the desired actions. When a user selects, or a policy automatically triggers an actionable event, the AMA controller 202 or other server process will send the appropriate message to the specific AMA, and the AMA controller 202 can then push the full package for installation on the VM. Alternatively, the AMA can pull the full package to install the entire WSA.

It should be noted that although the description may describe message passing as a ‘pull’ or ‘push’ action, either model may be employed. Under certain circumstances, one method may be preferred, and for security purposes a pull model is generally favored. However, actual implementations depend on system constraints and requirements.

As a final step, the application management agent 206 also performs upgrades to itself, 308, as initiated by the AMA controller 202. In general, it is not expected that an AMA will change frequently, as its sole purpose is to be a lightweight agent that does minimum work to get the full WSA agent installed on the system based on workload type and the user rules and policies. However, if an AMA requires an update, such as because of a bug fix, improved workload type detection, etc., the AMA can download its own package from AMA controller, and starts a monitoring process until it replaces its own package/binary with the new version. The AMA is expected to be a single small binary with minimal or no dependency to the specific version of system libraries.

In an embodiment, the AMA controller 202 is configured to work as a single point of contact for any practical number of VMs, and is responsible for communication with each AMA in each VM. The AMA controller might be provided as a horizontally scalable service such as in a microservice architecture. As a microservices-based application, the AMA controller uses a distributed architecture with multiple services interacting each other. These services may run on single machine or highly available clustered machines. These microservices also interact with other software service running on different machine such as agents running on different host. Each service instance is performing unique set of tasks which is independent of other services and communicates with other microservices using either REST API or message bus architecture. To serve a single user request, a microservices-based application can call on many other microservices to compile a response.

Alternatively, the AMA controller may be provided as a standard application that interacts with other applications using standard function calls and interfaces.

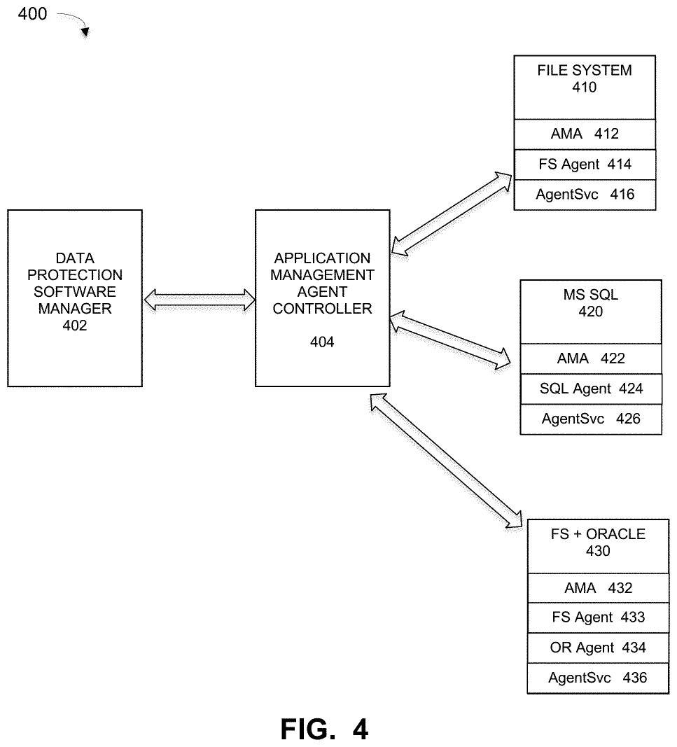

FIG. 4 illustrates the interaction between an application server and each application management agent through an AMA controller, under some embodiments. System 400 illustrates an example case of where the system is a data protection system (e.g., Dell PowerProtect DPA), and each PowerProtect DPS workflow-specific agent (WSA) includes a common AgentService process. System 400 is provided for purposes of illustration only, and any application with similar VMs, agents and service processes may be used. Likewise, it should be noted that while the description describes VM-based application and data protection systems, embodiments of the AMA and AMA controller system can be used on a physical machines or containers.

FIG. 4 illustrates an example system in which a data protection software manager 402 interacts with three (or more) VMs 410, 420, and 430 through an application management agent controller 404. Each VM performs a specific task, such as VM 410 being a filesystem (FS) VM, VM 420 being a database (e.g., MS SQL) VM, and VM 430 being a file system and database (e.g., Oracle) VM. Each VM has its own respective application management agent 412, 422, 432, and a common agent service 416, 426, 436. In addition, each has one or more workload-specific agents WSAs 414, 424, 434. For the example of FIG. 4, VM 430 is both a filesystem and database VM so it has a filesystem agent 433 and a database (OR) agent 434.

During the course of operation over a period of time, the agents may be changed, modified, upgraded, and so on. This continuous process is performed by a lifecycle management process initiated by the application manager 402. Under present systems, once the full WSA (e.g., 414) is installed on a VM (e.g., 410), the application manager 402 can use an existing agent lifecycle management to keep those VM agents up to date. For example, the PowerProtect Data Manager Data Protection Software supports push upgrades of the agents registered to it. In an embodiment, the VM resident AMA (e.g., 412) can initiate the upgrade of a VM when there is a new version of the WSA agent based on agent installation policies or user driven workflow. If there is a change in the workload, the AMA will install the new WSA agent accordingly.

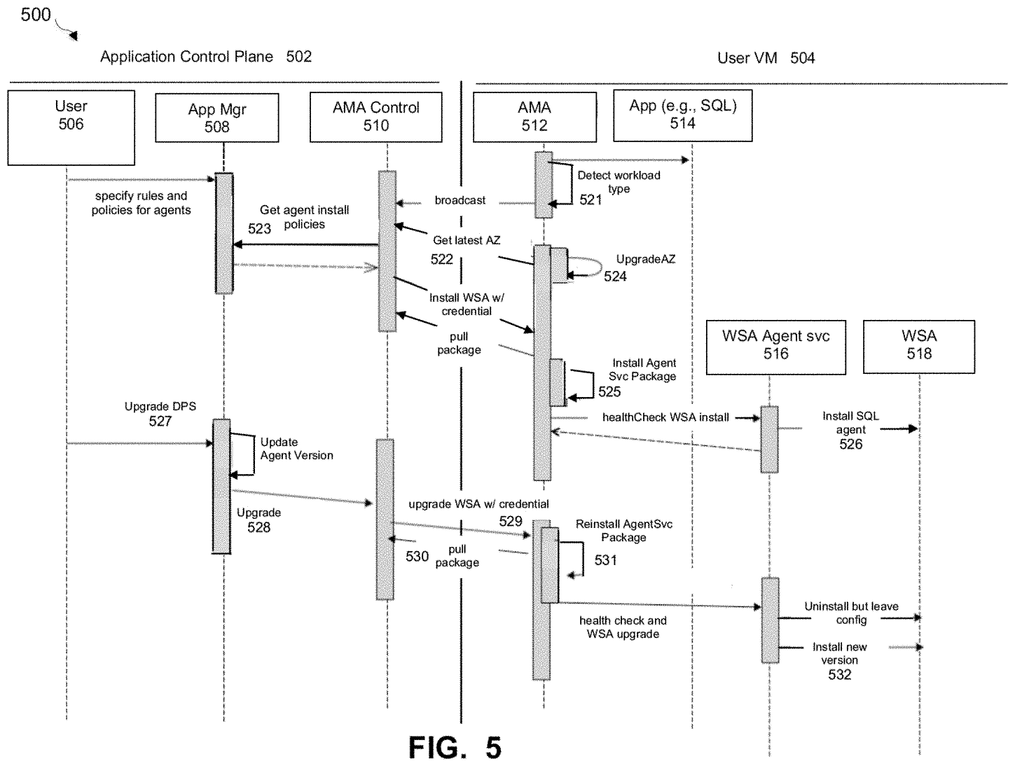

FIG. 5 is an end-to-end AMA sequence diagram showing the interaction among the various components of FIG. 4 during an automatic update of a VM application, under an example embodiment. Diagram 500 of FIG. 5 shows an application control plane 502 comprising a user 506, an application manager 508 (e.g., data protection software manager 402), and an AMA controller 510. The user VM plane 504 has the AMA 512, the application 514 (e.g., SQL), the WSA 518, and a WSA agent service 516. The flow processes of FIG. 5 illustrate the main process steps of FIG. 3 in greater detail and with reference to a specific example of upgrading the data protection software (DPS) running on the VM 504 through the AMA controller 510 and AMA 512 components.

A first step 521 in process 500 is the AMA 512 detecting or determining the workload type for the VM 504 (corresponding to step 302 in process 300) by querying the application 514 in the VM. Through a first interchange 522 with the AMA controller 510, the AMA 512 obtains agent installation and update policies, 523 as specified by the user 506, along with an upgrade to the AMA itself, if available, 524.

If a new WSA agent 518 is to be installed in the VM 504, the AMA installs 525 the agent service package 516, and this agent service then installs 526 the WSA (e.g., SQL) agent 518.

If there is an upgrade 527 of the application (e.g., DPS) from the user 506, the application manager 508 sends 528 the upgrade to the AMA controller 510, which then upgrades 529 the WSA to the AMA 512. The AMA gets the upgrade through a pull operation 530 and reinstalls 531 the agent service package. The agent service 516 then installs 532 the new version of the application to the WSA 518.

For the example of FIG. 5, the AMA may be referred to as ‘AZ’ for Agent Zero denoting the fact that it is the highest or zero-level agent in the VM.

The AMA may be installed in the VM by any one of a number of possible installation processes. For example, it may be installed through container templates or bare-metal OS reimaging, or similar processes.

As stated above, in an embodiment, the AMA is installed in the VM as part of a Gold image process. In general, application and OS data are well defined by the vendors and comprise all the program data prior to or minus any user data generated by a user using the application or OS. This structural, non-content data comprises the “Gold image” data because it is core data related to the structure, operation, and deployment of the applications and operating systems, rather than user-generated data. For example, Gold image data may comprise kernels, interfaces, file systems, drivers, data element definitions, macros, scripts, configuration information, and other data that comprises the software ‘infrastructure’ of the system, rather than the software content of the system, and comprises data does not change as frequently as user data. Gold image data is usually maintained or stored in a Gold image library that defines a set of protected base image that can be shared among stored content data sets, but that is kept separate from those more dynamic data sets as they are processed routinely by the backup and restoration processes.

In general, Gold images contain executables (APIs, executable code like binaries, scripts, macros, and so on), while data comprises the information that a running process generates and not the executables. For purposes of the present description, the term ‘Gold image data’ relates to executables as opposed to user or application data.

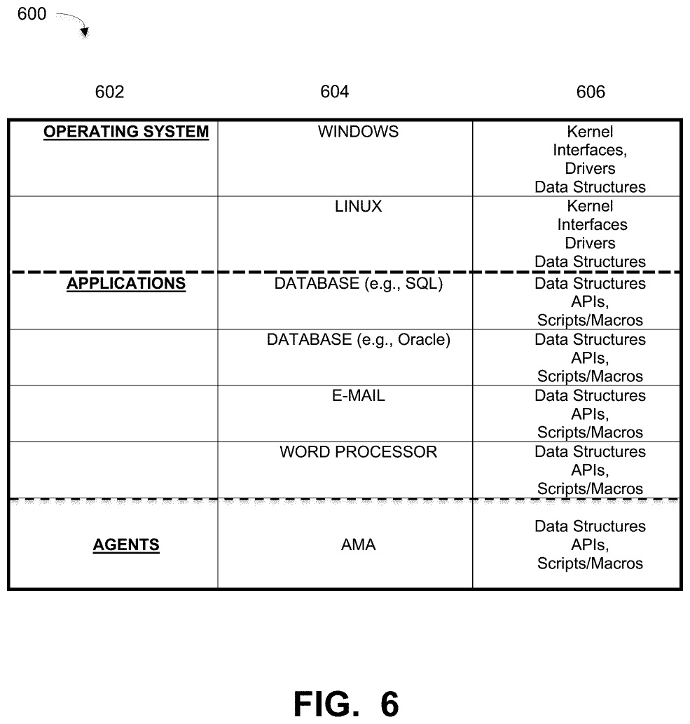

In an embodiment, the Gold image library is extended to include the AMA executables. FIG. 6 illustrates a table 600 showing a composition of a Gold image library storing OS and application executables, under some embodiments. As shown in table 600, the Gold image library comprises a repository storing base executables for fundamental system programs, such operating systems and applications, as well as any other infrastructural programs. Column 602 lists the one or more operating systems, and the one or more different applications and agents. Any number of different operating systems and applications may be used, and the example of table of FIG. 6 two different operating systems (Windows and Linux) and four example applications: SQL and Oracle databases with e-mail and word processing applications, as listed in column 604. The data elements in column 606 of table 600 represent the various programs, software definitions, and data for elements of the operating systems and applications that are written or defined by the manufacturer and sold or provided to the user under normal software release or distribution practices. As shown in FIG. 6, table 600 also includes a listing of agents, such as the application management agent, along with its specific definitions and data elements.

FIG. 6 is intended only to provide an example Gold image library, and embodiments are not so limited. Any structure or data composition may be used to define and store the Gold image executables comprising the data system.

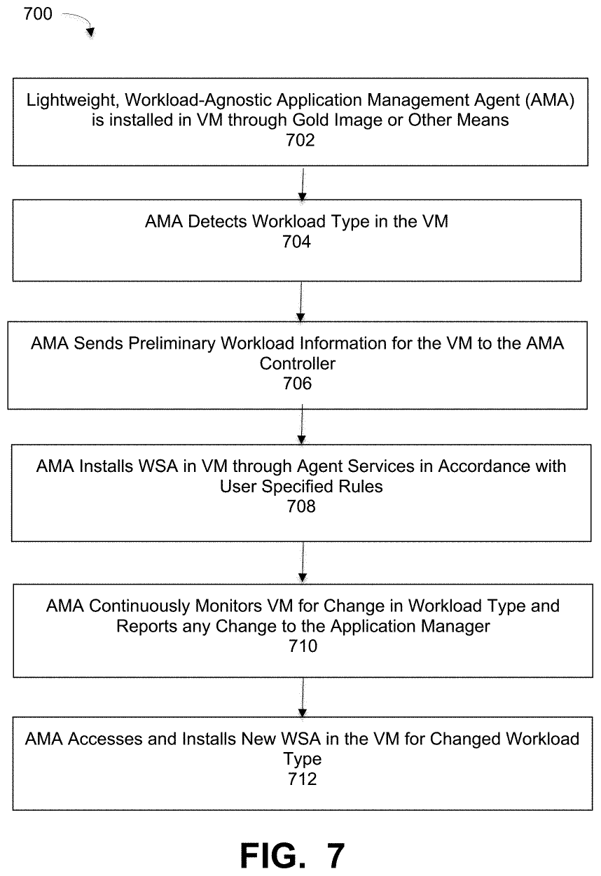

FIG. 7 is a flowchart illustrating an overall process of deploying and using an application management agent to upgrade application agents on a VM, under some embodiments. The AMA is provided as a lightweight, workload-agnostic agent seeded in the VM gold image, or installed through other processes (e.g., container templates or bare-metal OS reimaging), 702. The AMA performs automatic workload-type detection of the VM with an option for the user to override with their own rules in the AMA, 704. The AMA locates and broadcasts to an AMA controller, and sends preliminary workload information and possibly assets (e.g., database names) for the VM, 706.

The user can define their own agent installation policies to allow the lightweight AMAs embedded in their VMs to install and upgrade to full blown workload-specific agents, 708. The AMA continuously monitors the VM for any change in workload type and reports any such change to the application manager, 710. Any workload change causes the AMA to install the respective WSA agent for the new workload in the VM, 712. The AMA accesses the new WSA from the AMA controller and application manager though a push or pull operation. In this way, applications and WSAs in a VM can be upgraded automatically using automatic detection mechanisms and application push/pull routines. The user or system admin need only update the upgrade rules and provide the upgraded software to an application manager. The AMA, through the AMA controller and any WSA agent services coordinates the automatic upgrade of the WSA in the VM.

Embodiments of the processes and techniques described above can be implemented on any appropriate backup system operating environment or file system, or network server system. Such embodiments may include other or alternative data structures or definitions as needed or appropriate.

The processes described herein may be implemented as computer programs executed in a computer or networked processing device and may be written in any appropriate language using any appropriate software routines. For purposes of illustration, certain programming examples are provided herein, but are not intended to limit any possible embodiments of their respective processes.

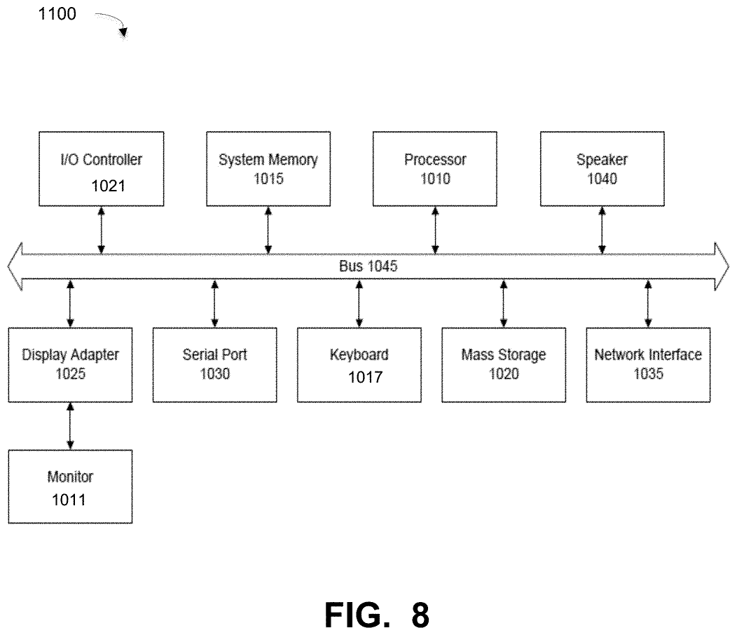

The network of FIG. 1 may comprise any number of individual client-server networks coupled over the Internet or similar large-scale network or portion thereof. Each node in the network(s) comprises a computing device capable of executing software code to perform the processing steps described herein. FIG. 8 shows a system block diagram of a computer system used to execute one or more software components of the present system described herein. The computer system 1100 includes a monitor 1011, keyboard 1017, and mass storage devices 1020. Computer system 1005 further includes subsystems such as central processor 1010, system memory 1015, I/O controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

Arrows such as 1045 represent the system bus architecture of computer system 1005. However, these arrows are illustrative of any interconnection scheme serving to link the subsystems. For example, speaker 1040 could be connected to the other subsystems through a port or have an internal direct connection to central processor 1010. The processor may include multiple processors or a multicore processor, which may permit parallel processing of information. Computer system 1100 is just one example of a computer system suitable for use with the present system. Other configurations of subsystems suitable for use with the described embodiments will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software.

An operating system for the system 1005 may be one of the Microsoft Windows®. family of systems (e.g., Windows Server), Linux, Mac OS X, IRIX32, or IRIX64. Other operating systems may be used. Microsoft Windows is a trademark of Microsoft Corporation.

The computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of the system using a wireless network using a protocol such as Wi-Fi (IEEE standards 802.11, 802.11a, 802.11b, 802.11e, 802.11g, 802.11i, 802.11n, 802.11ac, and 802.11ad, among other examples), near field communication (NFC), radio-frequency identification (RFID), mobile or cellular wireless. For example, signals from a computer may be transferred, at least in part, wirelessly to components or other computers.

In an embodiment, with a web browser executing on a computer workstation system, a user accesses a system on the World Wide Web (WWW) through a network such as the Internet. The web browser is used to download web pages or other content in various formats including HTML, XML, text, PDF, and postscript, and may be used to upload information to other parts of the system. The web browser may use uniform resource identifiers (URLs) to identify resources on the web and hypertext transfer protocol (HTTP) in transferring files on the web.

For the sake of clarity, the processes and methods herein have been illustrated with a specific flow, but it should be understood that other sequences may be possible and that some may be performed in parallel, without departing from the spirit of the described embodiments. Additionally, steps may be subdivided or combined. As disclosed herein, software written in accordance certain embodiments may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e., they take the place of a single computer. Various functions described above may be performed by a single process or groups of processes, on a single computer or distributed over several computers. Processes may invoke other processes to handle certain tasks. A single storage device may be used, or several may be used to take the place of a single storage device.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of automatically updating an application agent in a network resource, comprising:
installing a lightweight, workload-agnostic application management agent (AMA) in the network resource;
determining, by the AMA, a type of workload running on the network resource based on one or more application programs resident in the network resource, the one or more application programs operating through a resident workload-specific agent (WSA);
continuously monitoring the network resource to detect any change in the type of workload; and
installing, by the AMA and upon detection of any change, a new WSA in the network resource to update the application agent on the network resource.

2. The method of claim 1 wherein the network resource comprises one of: a virtual machine, a physical machine, or data containers coupled to an application server over a network.

3. The method of claim 2 wherein the network comprises a data storage system implementing a deduplication backup program, and wherein the network resource comprises a storage target.

4. The method of claim 3 wherein the network resource comprises a virtual machine, and wherein the AMA is installed in the VM as part of a Gold image installation on the VM.

5. The method of claim 3 wherein the network resource executes a data processing application comprising one of a filesystem or a database.

6. The method of claim 1 wherein the determining step comprises investigating application naming conventions or a presence of one or more known routines in the network resource.

7. The method of claim 6 further comprising allowing a user to modify workload detection rules used for the determining step to include recognition of one or more data elements to help identify the workload type.

8. The method of claim 1 further comprising reporting any change from the AMA to an AMA controller through a broadcast message or use of one or more network communication protocols.

9. The method of claim 8 further comprising setting user update policies through an application manager of the application server and coupled to the AMA controller, wherein the application manager allows a user to set agent deployment policies used by the AMA controller to automatically instruct the AMA to update the network resource upon the detection of the change.

10. The method of claim 1 wherein the installing step further comprises accessing by the AMA, a full, updated WSA package from an application manager for installation on the network resource.

11. The method of claim 1 wherein the AMA obtains the WSA package through one of a push operation from the application manager to the AMA, or a pull operation from the AMA to the application manager.

12. A method of automatically upgrading application agents on a virtual machine (VM), comprising:
installing an application management agent (AMA) in the VM as part of a Gold image installation;
detecting a change in workload-type of the VM for reporting to an application manager, the application manager defining updates automatically performable by the AMA on the VM based on the workload-type;
accessing an updated application component for installation on the VM in the event of a detected change and matching workload-type; and
installing, by the AMA the updated application component on the VM after the accessing step.

13. The method of claim 12 wherein the application component comprises a workload-specific agent (WSA) facilitating execution of an application of the workload-type on the VM.

14. The method of claim 13 wherein the accessing step comprises accessing a full, updated WSA package from an application manager for installation on the VM, and wherein the AMA obtains the WSA package through one of a push operation from the application manager to the AMA, or a pull operation from the AMA to the application manager.

15. The method of claim 12 wherein the application manager defines the updates performable by the AMA in accordance with update policies defined by a user.

16. The method of claim 12 further comprising automatically detecting, by the AMA, the workload type of the VM through investigating application naming conventions or a presence of one or more known routines in the VM.

17. The method of claim 12 wherein VM comprises a storage target in a data storage system implementing a deduplication backup program, and wherein the VM executes a data processing application comprising one of a filesystem or a database.

18. A system for automatically updating an application agent in a virtual machine (VM) comprising a data storage target in a network, the system comprising:
an application manager providing application elements for use by the VM;
an application management agent (AMA) installed as a lightweight, workload-agnostic agent in the VM, the AMA determining a type of workload running on the VM based an application program resident in the VM, the application program operates through a resident workload-specific agent (WSA), continuously monitoring the network resource to detect any change in the type of workload, and installing, upon detection of any change, a new WSA in the network resource to update the application agent on the VM; and
an AMA controller communicating to respective AMA agents installed on one or more additional VMs in the network.

19. The system of claim 18 wherein the AMA is installed in the VM as part of a Gold image installation on the VM, and further wherein the VM executes a data processing application comprising one of a filesystem or a database.

20. The system of claim 18 wherein the application manager allows a user to set agent deployment policies used by the AMA controller to automatically instruct the AMA to update the VM upon the detection of the change.
